(19) United States
(12) Patent Application Publication
(10) Pub. No.: US 2003/0063608 A1
(43) Pub. Date: Apr. 3, 2003

(54) Multicast discovery protocol uses tunneling of unicast message

(76) Inventor: Jan Renier Moonen, Sunnyvale, CA (US)

Correspondence Address: Philips Electronics North America Corporation, 580 White Plains Road, Tarrytown, NY, 10591, US

(21) Appl. No.: 09/970,539

(22) Filed: Oct. 3, 2001

(51) Int. Cl. H04L 12/56

(52) U.S. Cl. 370/390; 370/432

(57) ABSTRACT

The scope of discovery protocols on network domains of devices and services is extended. A search message or an announcement message on a multicast channel in one domain gets encapsulated into a unicast message that is sent to a second domain. The multicast message is extracted from the unicast message in the second domain and is input to the second domain's multicast channel.

### FIELD OF THE INVENTION

The invention relates to aspects and use of discovery procedures on a multi-domain network.

### BACKGROUND ART

Home network architectures such as HAVi, UPnP, Jini and VESA typically contain a device discovery protocol. This protocol is used to implement plug-and-play behavior, i.e., when a device is plugged into the network (or—in the wireless case—comes within range) it is automatically discovered by all interested parties, and can be used immediately. IP-based home networks such as UPnP and Jini build their discovery protocol on top of IP multicasting. In this case, a standard IP address and port are standardized as the multicast channel. Devices that join the network and want to announce themselves to the rest of the network send certain announcement messages to this channel. Devices that want to discover new devices simply listen to this channel.

Automatic discovery of devices is particularly important for wireless devices such as PDAs or mobile phones that enter or leave the (home) network, together with the person carrying them. However, automatic discovery is also relevant to non-mobile devices. These devices may be turned on or off by users at will, and in that sense enter or leave the network. Another reason why automatic discovery is important is the volatile nature of IP addresses. Typically, IP address allocation schemes such as DHCP assign IP addresses to devices on a temporary basis. In other words, a device discovered yesterday at IP address “A” might have IP address “B” tomorrow. The discovery protocol offers a mechanism for this device to announce itself at this new address, thereby ensuring that all interested clients become aware of this new address. Even if the device has not left or entered the home network from a user point of view, it has from a network point of view. Hence, discovery is not just a one-time-only activity performed when a device is brought home from a store and placed into a home network. Rather, it is a setup process that needs to be performed every time a user or application wants to use and control certain types of devices.

### SUMMARY OF THE INVENTION

Discovery based on IP multicasting gives rise to some problems. For example, IP multicasting is not generally supported throughout the whole Internet. Many IP routers and firewalls/gateways simply block all multicast traffic. As another problematic aspect, IP multicasting does not scale. A multicast message needs to have a Time-To-Live (TTL) field specifying the scope of the multicast message. The TTL field specifies the number of routers that this packet may traverse, and is needed to avoid flooding the whole Internet with these messages. The IP multicast routing protocol uses the TTL field of IP datagrams to decide how “far” from a sending host a given multicast packet should be forwarded. The default TTL for multicast datagrams is unity, which results in multicast packets going only to other hosts on the local network. It is generally impossible to know the number of routers in a path between two devices. Hence is it generally unknown to predict a sensible TTL value, and there is no guarantee in advance that a multicast message will reach all relevant destinations.

The inventor has realized that a TTL value can be used to specify clusters of devices that can discover each other. An aspect of this invention relates, among other things, to a mechanism to connect multiple ones of such clusters via “tunneling” of these multicast messages inside point-to-point (or unicast) messages exchanged between Extended Discovery Servers. The result is that devices and applications in separate clusters, residing at locations remote from each other and connected through these servers, can now discover and control each other.

An aspect of the invention therefore relates to a method of bridging a plurality of multicast domains. A multicast message, originating in a specific one of the domains, is enabled to be transferred as a unicast message to at least another one of the domains. Then, the multicast message is enabled to be re-generated from the unicast message in the other domain.

Another aspect of the invention relates to hardware or a software component for use on a first multicast domain, e.g., a first part of a home network. The component is operative to encapsulate a multicast message in a unicast message for being sent to a second multicast domain, e.g., a second part of the home network.

The invention allows to extend the scope of discovery protocols via multicast tunneling and reference translation: a search message or an announcement message on a multicast channel in one domain gets encapsulated into a unicast message that is sent to a second domain. The multicast message is extracted from the unicast message in the second domain and is input to the second domain's multicast channel.

### BRIEF DESCRIPTION OF THE DRAWING

The invention is explained below in further detail, by way of example, and with reference to the accompanying drawing, wherein:

FIGS. 1 and 2 are event diagrams illustrating searching and announcement events in a multicast domain;

FIGS. 3 and 4 are event diagrams illustrating the tunneling of a multicast messages between two multicast domains;

FIGS. 5 and 6 are event diagrams illustrating the tunneling between multicast domains with a UPnP configuration.

Throughout the figures, same reference numerals indicate similar or corresponding components or features.

### DETAILED EMBODIMENTS

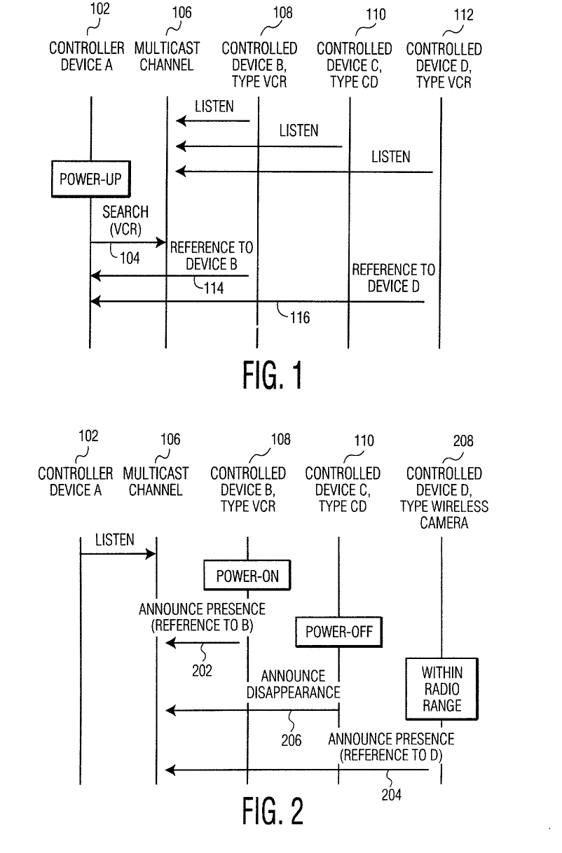

FIGS. 1 and 2 are event diagrams illustrating searching and announcing events in a single multicast domain. A typical discovery protocol involves devices (or software applications) that assume one of two possible roles: on the one hand a controlled device or server; and on the other hand a controller device or client application. A discovery protocol implements active searching by controller devices for controlled devices (of a particular type).

In FIG. 1, a controller device 102 sends a search message 104 to a multicast channel 106. Controlled devices 108, 110 and 112 listen to multicast channel 106. Relevant ones of controlled devices 108-112 send unicast responses 114 and 116 to device 102, the sender of search message 104.

In FIG. 2, controlled devices 108 and 208 send announcement messages 202 and 204 to multicast channel 106 to announce their presence, e.g., periodically or upon a certain event such as “power-on” or “coming within range” as for device 208. Controlled device 110 sends announcement messages 206, to multicast channel 106 to announce its imminent disappearance (e.g., in case of a power shutdown).

Search responses 114 and 116 and presence announcements 202,204 contain respective references to the respective discovered devices. A reference comprises, e.g., an IP address or a URL. Subsequent interaction with the discovered device is based on this reference.

This invention introduces a software component referred to herein as an “Extended Discovery Server” (EDS) that can be added to a (home) network in order to enable the devices on this network to discover (or be discovered) and be used by remote devices. The EDS needs to be connected, through the Internet or another Wide Area Network (WAN), to one or more remote EDSs. It needs to know global references to these EDSs, such as static global IP addresses or registered Internet domain names. The operation of an EDS is described below for two scenarios: a controller device searches for remote devices to interact with, and a controlled device announces its presence or imminent disappearance to remote controller devices.

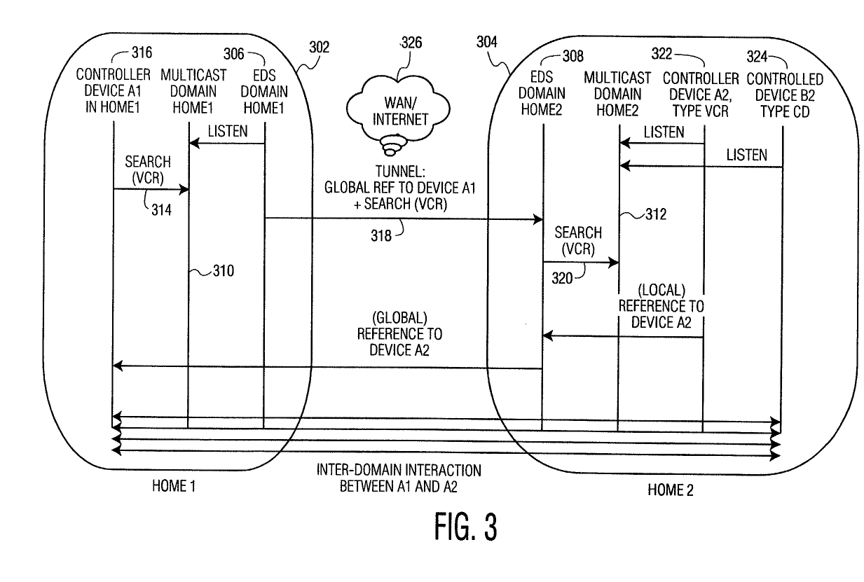

FIG. 3 illustrates a scenario with events in a domain 302 and a domain 304, e.g., Home1 and Home2, respectively. Domain 302 has an EDS 306 and domain 304 has an EDS 308. EDSs 306 and 308 enable to share their networks, i.e., domains 302 and 304, with one another. EDSs 306 and 308 both listen to messages on multicast channels 310 and 312. In the example shown, a search message 314 is detected by EDS 306 in domain 302. EDS 306 encapsulates multicast message 314 together with a reference to the multicast sender, here a device 316, in a new unicast message 318. In case original multicast sender 316 in domain 302 was using a local reference, that reference is translated via, for example, NAT, and replaced by an equivalent global reference. EDS 306 then sends encapsulated multicast message 318 as unicast message via WAN 326 to one or more other EDSs that it wants to share devices with. In this example, the relevant other EDS is EDS 308. When EDS 308 receives message 318 from EDS 306, the former extracts the encapsulated search message 314 and the global reference of original multicast sender 316. EDS 308 then sends extracted search message 320 to a multicast channel 312 in domain 304. Thus, original multicast message 314 is regenerated in a different multicast domain as if it has tunneled from domain 302 via WAN 326 into domain 304. Since EDS 308 is the sender of regenerated multicast message 320, it will receive the response, if any, to this search message. Each response received from devices in domain 304, e.g., devices 322 and 324, will be forwarded to sender 316 of the original search in domain 302. In case the responses contain local references, those references are translated via, for example, NAT, and replaced by equivalent global references. Now that controller device 316 in domain 302 has discovered controlled device 322 in domain 304 that it searched for, it can use the references received to interact with devices 322 and 324. The actual mechanism to implement this is independent of this invention. Usually, these mechanisms are based on unicast, such as HTTP.

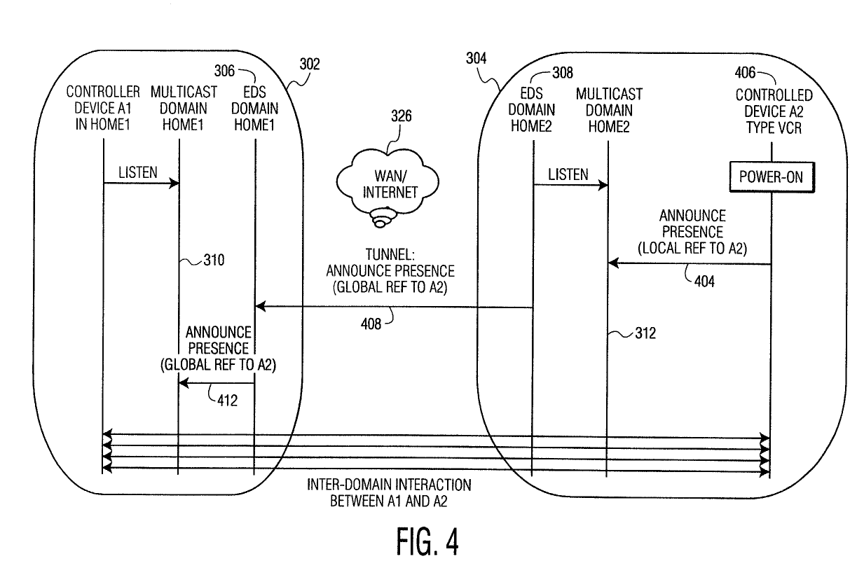

FIG. 4 illustrates a scenario with events in domains 302 and 304, wherein a device 402 announces its presence. EDSs 306 and 308 listen to messages on the standardized multicast channels 310 and 312, respectively. Whenever an announcement message 404 is detected by an EDS, in this scenario by EDS 308 in domain 304, the relevant EDS encapsulates the entire multicast message 404. In case announcement 404 contains a local reference, e.g., to its sender device 406, that reference is translated via, for example, NAT and replaced by an equivalent global reference. EDS 308 then sends the encapsulated multicast message 408 as unicast message via WAN 326 to one or more other EDSs, in this scenario, EDS 306. When EDS 306 receives unicast message 408 from EDS 308, the former extracts encapsulated announcement message 404 from message 408. EDS 306 then sends the extracted announcement message 412 to multicast channel 310 in domain 302. Thus, original multicast message 404 is regenerated in a different multicast domain as if it had tunneled from domain 304 via WAN 326 to domain 302. Now that announcement 404 has been regenerated in domain 302 as message 412, controller devices in domain 302 are aware of new device 406 in domain 304 and can interact with device 404 through the reference contained in announcement message 412. The actual mechanism to do this is independent of this invention. Usually, these mechanisms are based on unicast, such as HTTP.

The invention allows entities that can be discovered within a single domain, e.g., a home network or another restricted area, to be discovered by remote applications, in a controlled way. The entities can be devices such as those based on UPnP, services, individual pieces of audio/video (AV) content information, or even persons associated with a personal device such as a PDA or mobile phone. The reach of the extended discovery protocol is determined by the set of EDSs that know each other's network address.

For example, a group of three friends might decide to share their home network by establishing a relation between their EDSs. Another example is a mobile professional that establishes a relation between his EDS at home and his EDS at work or vacation location. The actual mechanism to establish these relation is independent of the object of this invention.

After discovery a remote entity through the EDS mechanism, the entity may be used/controlled. For example: a security camera in a home may be inspected from a work or vacation location; a song or video stored in a friends home may be downloaded or streamed to your own home; a VCR in a home may be programmed from a remote location; a device may be turned off from a remote location, to save energy, for example one's home network can be monitored remotely, for example, to detect intrusions/abnormalities such as devices disappearing without authorization or applications searching for devices at odd times of the day.

An EDS may implement a filtering mechanism, to allow remote access only to certain devices in the home, or only at certain times of the day, or only to certain ‘trusted’ remote EDSs. This filtering can also be personalized per user.

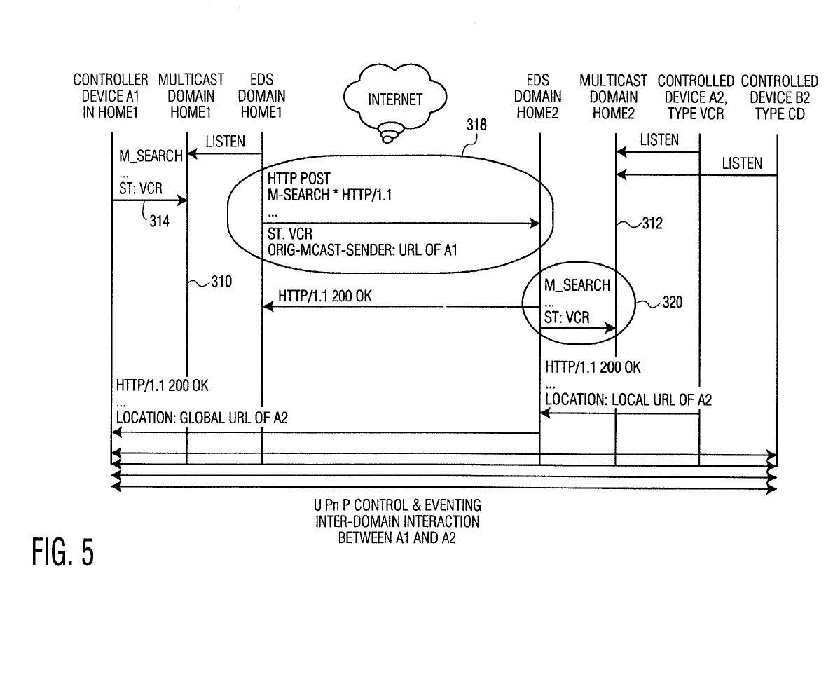

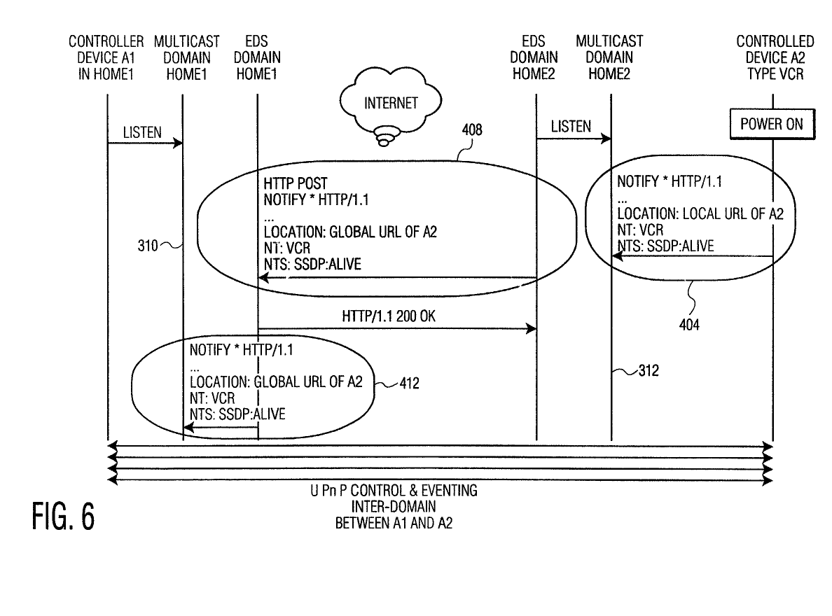

FIGS. 5 and 6 illustrate the above in some more detail for multicast domains with UPnP configurations. The UPnP standard defines a discovery protocol referred to as Simple Service Discovery Protocol (SSDP). It is used to discover either UPnP devices or UPnP services. In UPnP terminology, a service is a functional component that is part of a UPnP device. SSDP uses a standard multicast channel, 239.255.255.250:1900, and a TTL of 4. SSDP defines the following messages:

NOTIFY (ssdp:alive): periodically sent by a controlled device to the multicast channel to announce its presence. Contains a URL reference to the devices' description document.

NOTIFY (ssdp:byebye): sent by a controlled device to the multicast channel to announce its imminent disappearance.

M-SEARCH (<search-target>): sent by a controller device to the multicast channel to search for specific device types, service types, device instances or all devices. Controlled devices that match the <search target> need to respond to the sender of the search with a message containing a URL reference to the device's description document.

After a controller device has used SSDP to discover a device that it is interested in, it has the URL to the device's document. It can subsequently fetch this document and parse it to find references to the services (=functional components) that the device contains. It can then use those references to actually interact with this device. The references are in the form of URLs, and interaction is based on using the HTTP protocol (via a POST message) between controller device and controlled device.

In some homes, the URL references that a device uses to announce itself are based on a so-called ‘local’ IP address, meaning that the address is not globally unique, and the URL reference is not usable on the global Internet. In such a home, at least one device—e.g., the Internet Gateway—has a global IP address. This Internet Gateway typically implements NAT (Network Address Translation) or NAPT (Network Address Port Translation), which is a mechanism to map a local IP address plus port to a global IP address plus port. The EDS can use this mechanism to replace local addresses by a global address for all SSDP messages that leave the home to travel the Internet and arrive at a remote home. Specifically, this concerns the following messages:

NOTIFY (ssdp:alive) of a local device;

response to a remote M-SEARCH (<search-target>) message;

In this embodiment, the unicast message used to tunnel is an HTTP POST mechanism. The HTTP body contains the complete SSDP message (the SSDP header+body) plus, in case of an SSDP search, the IP address and port of the sender. This latter information is encoded as an HTTP header called ‘ORGINAL-MCAST-SENDER’. The EDSs in this embodiment know each other, in the form of a URL reference.

More specifically, a tunneled search message looks like this:

POST <path of URL of EDS> HTTP/1.1

M-SEARCH HTTP/1.1

HOST: 239.255.255.250:1900

MAN: “ssdp:discover”

MX: <seconds to delay response>

ST: <search target>

ORGINAL-MCAST-SENDER: <global IP address and port of the multicast sender>

A tunneled announcement of presence message looks like this:

POST <path of URL reference of remote EDS> HTTP/1.1

NOTIFY*HTTP/1.1

HOST: 239.255.255.250:1900

CACHE-CONTROL: max-age=<seconds until advertisement expires>

LOCATION: <global URL reference to the device>

NT: <search target>

NTS: “ssdp:alive”

SERVER: <OS/version> UPnP/1.0 <product/version>

USN: <advertisement UUID>

A tunneled announcement of imminent disappearance message may look like:

POST <path of URL of EDS>HTTP/1.1

NOTIFY*HTTP/1.1

HOST: 239.255.255.250:1900

NT: <search target>

NT: “ssdp:byebye”

USN: <advertisement UUID>

The HTTP POST response to this would be a standard ok response, in all cases:

HTTP/1.1 200 OK

Parts of the above messages that are enclosed in brackets (“<” and “>”) are not to be taken literally, but are to be interpreted as defined in the UPnP SSDP specification.

FIGS. 5 and 6 are event diagrams showing the scenarios for search tunneling corresponding to FIG. 3, and for announcement tunneling corresponding to FIG. 4. The events have been rephrased in terms specific to this UPnP/SSDP/HTTP embodiment.

Incorporated herein by reference are the following patent documents:

U.S. Ser. No. 09/635,548 (attorney docket US 000107) filed Aug. 10, 2000 for Eugene Shteyn and Paul Rankin for MOBILE MICRO PORTAL. This document relates to covering a geographic region has a network of beacons. Each beacon transmits a short-range facilitation signal for receipt on a user's mobile communication device. The facilitation signal initiates associating the facilitation signal with a service and conditionally alerts the user to the service via the device dependent on a user profile. The user-profile and the association between facilitation signal and service are user-programmable.

U.S. Ser. No. 09/844,570 (attorney docket US 018052) filed Apr. 26, 2001 for Eugene Shteyn for DISTRIBUTED STORAGE ON A P2P NETWORK ARCHITECTURE. This document relates to an electronic content delivery system that uses a network of end-user devices around a hub. Each end-user device has storage capability. Content is stored in a distributed fashion on the network of these end-user devices for being made available to individual ones of these devices in a P2P fashion so as to cut download time and reduce transmission errors.

U.S. Ser. No. 09/616,632 (attorney docket US 000184) filed Jul. 26, 2000 for Jean Moonen et al., for SERVER-BASED MULTI-STANDARD HOME NETWORK BRIDGING. This document relates to a bridge in a network that couples first and second clusters of devices. The clusters have different software architectures. The bridge is connected to a server on the Internet. This server offers a lookup service for some set of standards, and allows a bridge to locate and download the appropriate translation modules for allowing a device in the first cluster to interact with the second cluster.

U.S. Ser. No. 09/340,272 (attorney docket PHA 23,634) filed Jun. 25, 1999 for Eugene Shteyn for BRIDGING MULTIPLE HOME NETWORK SOFTWARE ARCHITECTURES. This document relates to integrating networks of different software architectures with each other. References to software representations of devices and services on a first one of the networks are automatically created. The references are semantically sufficient to enable automatic creation of at least partly functionally equivalent software representations for a second one of the networks so as to make the devices and services of the first network accessible from the second network.

What is claimed is:

1. A method of bridging a plurality of multicast domains, the method comprising:
enabling to transfer a multicast message, originating in a specific one of the domains, as a unicast message to at least another one of the domains;
enabling to regenerate the multicast message from the unicast message in the other domain.

2. The method of claim 1, wherein the multicast message comprises a search message for discovery of a device or service.

3. The method of claim, wherein the multicast message comprises an announcement message for announcing presence of a device or service.

4. The method of claim 1, wherein at least part of the specific domain or the other domain forms part of a wireless network.

5. The method of claim 1, using IP multicasting.

6. The method of claim 1, wherein at least one of the domains has a UPnP architecture.

7. A unicast message on a data network, a multicast message being encapsulated in the unicast message.

8. A component for use with a multicast domain, the component being operative to encapsulate a multicast message, received from a multicast channel in the multicast domain, in a unicast message.

9. A component for use with a multicast domain, the component being operative to extract a multicast message from a unicast message for forwarding the multicast message to a multicast channel of the multicast domain.
